(19) United States
(12) Patent Application Publication
(10) Pub. No.: US 2024/0213706 A1
(43) Pub. Date: Jun. 27, 2024

(54) WIRE CONNECTION MODULE AND PLUG CONNECTOR HAVING THE SAME

(71) Applicant: ADVANCED-CONNECTEK INC., New Taipei City (TW)

(72) Inventors: Ming-Yung CHANG, New Taipei City (TW); Chun HUANG, New Taipei City (TW)

(21) Appl. No.: 18/394,162

(22) Filed: Dec. 22, 2023

(30) Foreign Application Priority Data
Dec. 23, 2022 (TW) 111214318

(51) Int. Cl. H01R 13/514; H01R 13/434; H01R 13/436; H01R 13/518; H01R 24/20

(52) U.S. Cl. CPC H01R 13/514; H01R 13/434; H01R 13/436; H01R 13/518; H01R 24/20

(57) ABSTRACT

A wire connection module and a plug connector are provided. The plug connector includes a housing and a plurality of wire connection modules. The housing has a plurality of receiving spaces, and the housing has a plurality of first mating surfaces respectively at inner sides of the receiving spaces. The wire connection modules are respectively in the receiving spaces. The wire connection module includes an outer member, an insulated member, and a tail cap. The outer member has a receiving groove, one of two ends of the outer member has a mating side, the other end of the outer member has an assembling side, the insulated member is in the receiving groove, and the tail cap is mated with the assembling side and assembled outside an outer portion of the outer member. An outer portion of the tail cap is positioned at the first mating surface.

### CROSS-REFERENCE TO RELATED APPLICATION

This non-provisional application claims priority under 35 U.S.C. § 119(a) to Patent Application No. 111214318 filed in Taiwan, R.O.C. on Dec. 23, 2022, the entire contents of which are hereby incorporated by reference.

### FIELD OF THE INVENTION

The instant disclosure relates to a connector, and more particular to a wire connection module and a plug connector having the same.

### BACKGROUND

For data transmission within a vehicle, the amount of the data is large, and a high transmission speed is needed. Within a vehicle, data transmission is achieved through the connection of a plug connector and a receptacle connector. For example, during the autonomous operation of the vehicle or the application of a driver assistance system, data from cameras, sensors, and navigation devices are transmitted within the vehicle.

### SUMMARY OF THE INVENTION

A plug connector, known to the inventor, has a wire connection module including a contact member, an inner member, and a connection member. During the assembly of the wire connection module, a contact portion at a front end of the connection member is inserted into the contact member. An outer surface of the contact portion contacts an inner surface of the contact member, and an outer surface of a small portion of the inner member is enclosed by the contact portion. Thus, the portion of the inner member enclosed by the contact portion is short and small. As a result, when the inner member is impacted, for example, during the assembling process of the contact member, the inner member will be displaced and detached from the contact portion. Hence, the assembling of the wire connection member is failed.

In view of these considerations, one or some embodiments of the instant disclosure provide a wire connection module. The wire connection module comprises an outer member, an insulated member, and a tail cap. The outer member has a receiving groove. One of two ends of the outer member has a mating side, and the other end of the outer member has an assembling side. The insulated member is in the receiving groove. The tail cap is mated with the assembling side of the outer member and is assembled outside an outer portion of the outer member.

In some embodiments, the outer member has a plurality of combining portions, the insulated member has a plurality of positioning portions, and each of the combining portions is engaged with a corresponding one of the positioning portions.

In some embodiments, each of the combining portions is a groove, and each of the positioning portions is a protrusion.

In some embodiments, the wire connection module further comprises a terminal, and the insulated member has a terminal groove for being assembled with the terminal.

In some embodiments, the insulated member has a through hole in communication with the terminal groove, and the terminal has a thorn portion engaged with the through hole.

In some embodiments, an outer side of the insulated member has a recessed portion corresponding to an opening of the through hole.

In some embodiments, the mating side of the outer member has a mating ring portion, the assembling side of the outer member has an assembling ring portion, and an outer diameter of the mating ring portion is less than an outer diameter of the assembling ring portion.

In some embodiments, the tail cap has a fitting ring portion fitted over the assembling ring portion, and a length of the fitting ring portion is less than a length of the assembling ring portion.

One or some embodiments of the instant disclosure provide a plug connector. The plug connector comprises a housing and a plurality of wire connection modules. The housing has a plurality of receiving spaces, and the housing has a plurality of first mating surfaces respectively at inner sides of the receiving spaces. The wire connection modules are respectively in the receiving spaces. Each of the wire connection modules comprises an outer member, an insulated member, and a tail cap. For each of the wire connection modules, the outer member has a receiving groove, one of two ends of the outer member has a mating side, the other end of the outer member has an assembling side, the insulated member is in the receiving groove, and the tail cap is mated with the assembling side of the outer member and assembled outside an outer portion of the outer member. An outer portion of each of the tail caps is positioned at a corresponding one of the first mating surfaces.

In some embodiments, for each of the wire connection modules, the mating side of the outer member has a mating ring portion, the assembling side of the outer member has an assembling ring portion, an outer diameter of the mating ring portion is less than an outer diameter of the assembling ring portion, the outer member has a bent portion between the mating ring portion and the assembling ring portion; the housing comprises a plurality of stopping blocks, and each of the stopping blocks is at the inner side of a corresponding one of the receiving spaces and leans against a corresponding one of the bent portions.

In some embodiments, the housing has a plurality of second mating surfaces respectively at the inner sides of the receiving spaces, each of the second mating surfaces is between a corresponding one of the first mating surfaces and a corresponding one of the stopping blocks, and the outer portion of each of the outer members is positioned at a corresponding one of the second mating surfaces.

According to some embodiments of the instant disclosure, the tail cap is mated with the outer portion of the outer member, and a large portion of the outer member encloses the outer portion of the insulated member. Therefore, when the wire connection module is impacted or displaced, the insulated member is not displaced or detached from the outer member due to the impact of the wire connection member. Moreover, in some embodiments, through the combination between the combining portions of the outer member and the positioning portions of the insulated member, the degree of freedom of the axial rotation of the outer member with respect to the insulated member can be limited, and a mistake-proofing function can be provided for the combination between the outer member and the insulated member. Therefore, the insulated member can be properly limited in the outer member, and thus the stability of the insulated member can be enhanced and the orientation of the insulated member can be properly configured.

Detailed description of the characteristics and the advantages of the instant disclosure are shown in the following embodiments. The technical content and the implementation of the instant disclosure should be readily apparent to any person skilled in the art from the detailed description, and the purposes and the advantages of the instant disclosure should be readily understood by any person skilled in the art with reference to content, claims, and drawings in the instant disclosure.

### BRIEF DESCRIPTION OF THE DRAWINGS

The instant disclosure will become more fully understood from the detailed description given herein below for illustration only, and thus not limitative of the instant disclosure, wherein:

FIG. 1 illustrates a perspective view of a plug connector according to some embodiments of the instant disclosure, where the dashed line represents the outline of the wire connection module;

FIG. 2 illustrates a lateral cross-sectional view of the plug connector according to some embodiments of the instant disclosure;

FIG. 3 illustrates a perspective view of a wire connection module according to some embodiments of the instant disclosure;

FIG. 4 illustrates a front exploded view of the wire connection module according to some embodiments of the instant disclosure;

FIG. 5 illustrates a rear exploded view of the wire connection module according to some embodiments of the instant disclosure;

FIG. 6 illustrates a lateral cross-sectional view of the wire connection module according to some embodiments of the instant disclosure, where the outer member, the insulated member, and the tail cap are separated from each other;

FIG. 7 illustrates a lateral cross-sectional view of the wire connection module according to some embodiments of the instant disclosure, where the outer member, the insulated member, and the tail cap are assembled with each other; and

FIG. 8 illustrates a lateral cross-sectional view along the line A-A shown in FIG. 7.

### DETAILED DESCRIPTION

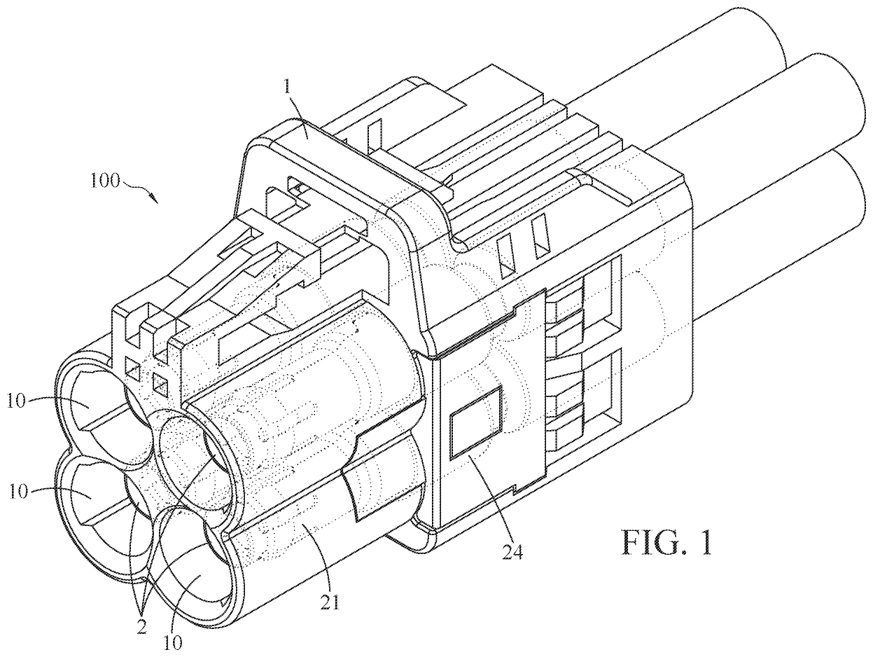

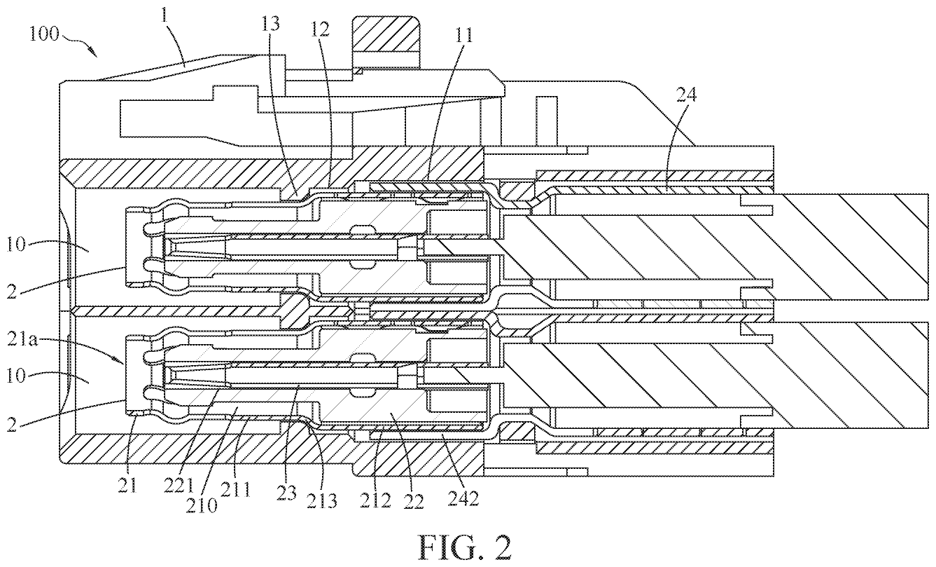

Please refer to FIG. 1 and FIG. 2. FIG. 1 illustrates a perspective view of a plug connector 100 according to some embodiments of the instant disclosure, where the dashed line represents the outline of the wire connection module. FIG. 2 illustrates a lateral cross-sectional view of the plug connector 100 according to some embodiments of the instant disclosure. In some embodiments, the plug connector 100 is provided for data transmission between electronic devices (e.g., antennas, radars) of a vehicle. The electronic devices are connected to each other through the plug connector 100 and a receptacle connector which are mated with each other and respectively connected to cables. The plug connector 100 comprises a housing 1 and a plurality of wire connection modules 2 (in some embodiments, the number of the wire connection modules 2 may be two, four, six, or seven, and the arrangement of the wire connection modules 2 may be a single-row configuration, a double-row configuration, or other array configurations).

The housing 1 has a plurality of receiving spaces 10. The housing 1 has a plurality of mating surfaces 11 respectively at inner sides of the receiving spaces 10.

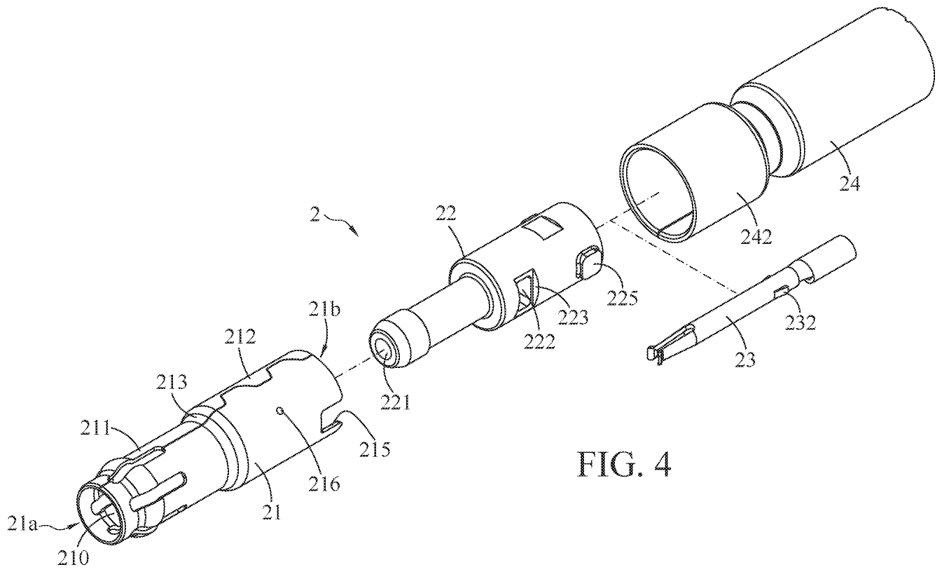

The wire connection modules 2 are respectively in the receiving spaces 10. The wire connection module 2 comprises an outer member 21, an insulated member 22, and a tail cap 24. The outer member 21 has a receiving groove 210. One of two ends of the outer member 21 has a mating side 21a, and the other end of the outer member 21 has an assembling side 21b (as shown in FIG. 4). The insulated member 22 is in the receiving groove 210. The tail cap 24 is mated with the assembling side 21b of the outer member 21 and is assembled to an outer portion of the outer member 21. An outer portion of each of the tail caps 24 is positioned at a corresponding one of the first mating surfaces 11.

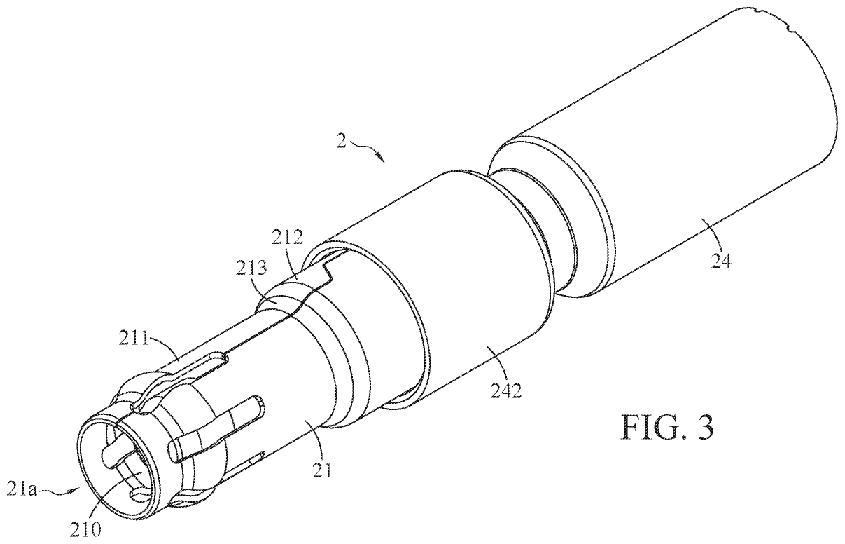

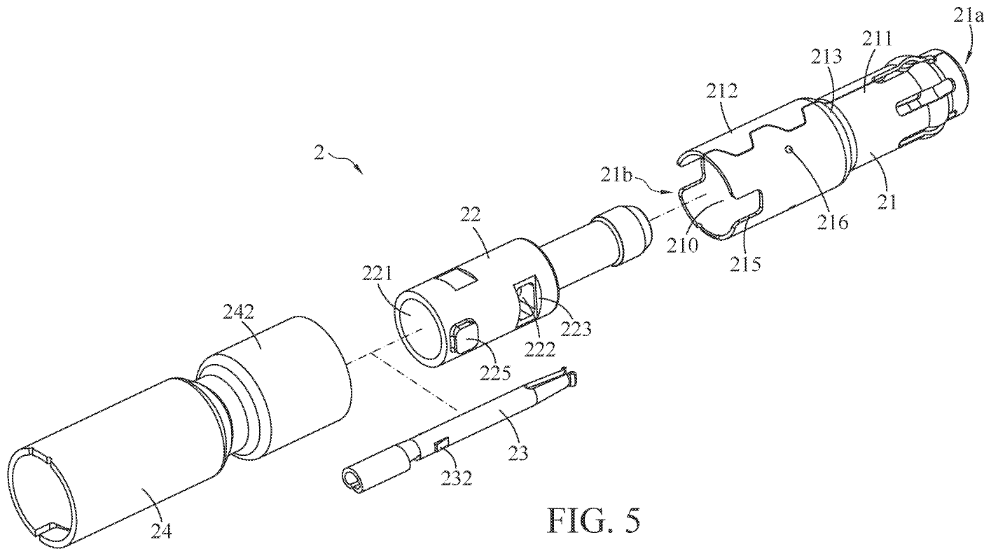

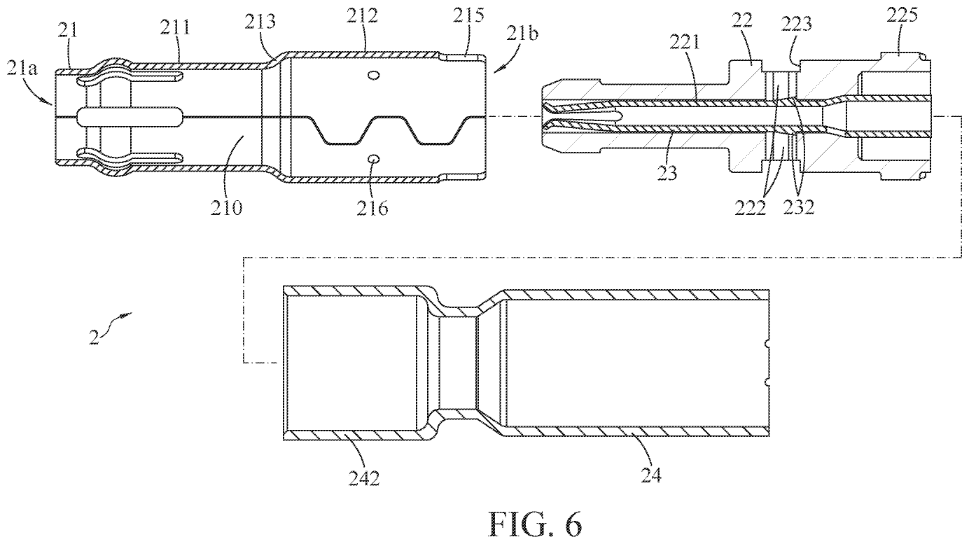

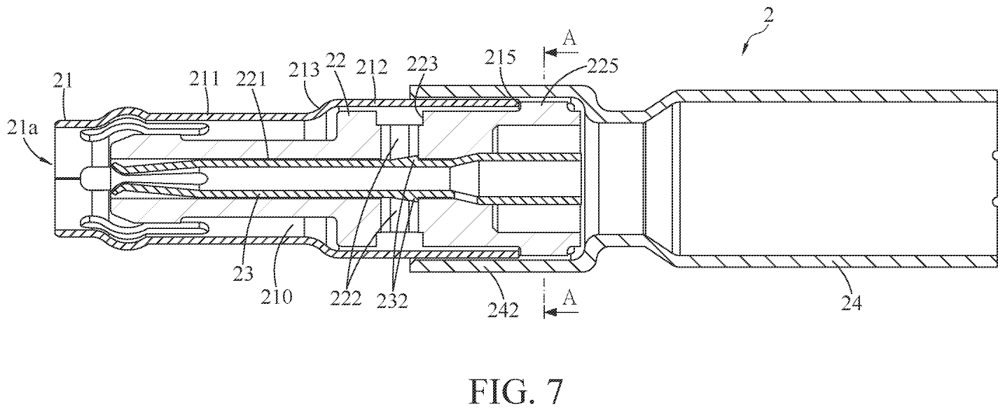

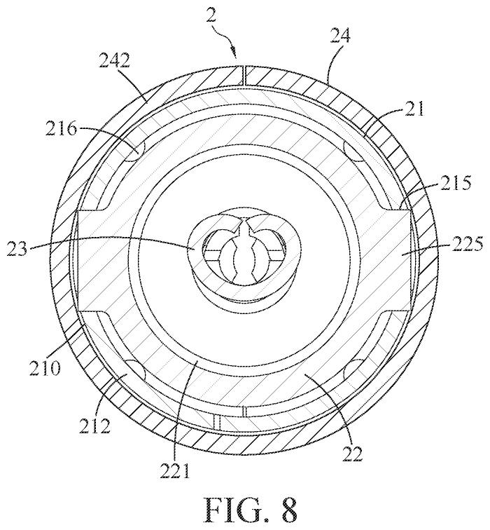

Please refer to FIG. 3 to FIG. 5. FIG. 3 illustrates a perspective view of a wire connection module 2 according to some embodiments of the instant disclosure. FIG. 4 illustrates a front exploded view of the wire connection module 2 according to some embodiments of the instant disclosure. FIG. 5 illustrates a rear exploded view of the wire connection module 2 according to some embodiments of the instant disclosure. For the assembling of the wire connection module 2, firstly, the insulated member 22 is installed in the receiving groove 210 of the outer member 21; next, the tail cap 24 is mated with the assembling side 21b of the outer member 21 and assembled to the outer portion of the outer member 21 (as illustrated in the unassembled lateral cross-sectional view shown in FIG. 6 and the assembled lateral cross-sectional view shown in FIG. 7). A cable may be assembled in the tail cap 24 (as shown in FIG. 2). A large portion of the outer member 21 encloses the outer portion of the insulated member 22 (as shown in FIG. 7 and FIG. 8). Therefore, when the tail cap 24 or the insulated member 22 is impacted or displaced, the insulated member 22 is not displaced or detached from the outer member 21.

Please refer to FIG. 1 and FIG. 2. In some embodiments, the housing 1 has a plurality of second mating surfaces 12 respectively at the inner sides of the receiving spaces 10. Each of the second mating surfaces 12 is between a corresponding one of the first mating surfaces 11 and a corresponding one of the stopping blocks 13. An outer portion of each of the outer members 21 is positioned at a corresponding one of the second mating surfaces 12. In this embodiment, from a lateral view, the first mating surface 11, the second mating surface 12, and the stopping block 13 are substantially formed as a tapered stepped structure.

Please refer to FIG. 2 and FIG. 4. In some embodiments, the mating side 21a of the outer member 21 has a front end and a plurality of elastic pieces annularly arranged around and integrally formed with the front end. When the wire connection module 2 is assembled in the receiving space 10 of the housing 1, the front end of the mating side 21a of the outer member 21 is nearer to the insertion opening at one of two ends of the receiving space 10 of the housing 1 as compared with the elastic pieces (in other words, in this embodiment, the distance between the front end and the insertion opening is less than the distance between the elastic pieces and the insertion opening; namely, when the plug connector is mated with a receptacle connector, the receptacle connector firstly contacts the front end of the outer member 21), and an outer portion of the tail cap 24 is positioned at an assembling opening at the other end of the receiving space 10. Therefore, the outer portion of the tail cap 24 of each of the wire connection modules 2 is positioned at a corresponding one of the first mating surfaces 11.

Please refer to FIG. 2 and FIG. 4. In some embodiments, the mating side 21a of the outer member 21 has a mating ring portion 211, the assembling side 21b of the outer member 21 has an assembling ring portion 212, and an outer diameter of the mating ring portion 211 is less than an outer diameter of the assembling ring portion 212. The outer member 21 further has a bent portion 213 between the mating ring portion 211 and the assembling ring portion 212. The housing 1 comprises a plurality of stopping blocks 13, and each of the stopping blocks 13 is at the inner side of a corresponding one of the receiving spaces 10 and leans against a corresponding one of the bent portions 213.

Please refer to FIG. 4 and FIG. 8. In some embodiments, the outer member 21 has a plurality of combining portions 215, and the insulated member 22 has a plurality of positioning portions 225. After each of the combining portions 215 of the outer member 21 is combined with a corresponding one of the positioning portions 225 of the insulated member 22, the degree of freedom of the axial rotation of the outer member 21 with respect to the insulated member 22 can be limited, and a mistake-proofing function can be provided for the combination between the outer member 21 and the insulated member 22. Therefore, the insulated member 22 can be properly limited in the outer member 21, and thus the stability of the insulated member 22 can be enhanced and the orientation of the insulated member 22 can be properly configured.

Please refer to FIG. 4 and FIG. 8. In some embodiments, each of the combining portions 215 is a groove, and each of the positioning portions 225 is a protrusion. Therefore, when each of the combining portions 215 of the outer member 21 is engaged with the corresponding one of the positioning portions 225 of the insulated member 22, the protrusion (the positioning portion 225) at the side portion of the insulated member 22 is combined with the groove (the combining portion 215) at the side portion of the outer member 21. Therefore, the degree of freedom of the axial rotation of the outer member 21 with respect to the insulated member 22 can be limited, and a mistake-proofing function can be provided for the combination between the outer member 21 and the insulated member 22. Therefore, the insulated member 22 can be properly limited in the outer member 21, and thus the stability of the insulated member 22 can be enhanced and the orientation of the insulated member 22 can be properly configured. In some embodiments, each of the combining portions 215 is a groove, and each of the positioning portions 225 is a protrusion, but the instant disclosure is not limited thereto. In some other embodiments, each of the combining portions 215 is a protrusion, each of the positioning portions 225 is a groove, and each of the protrusions is engaged with a corresponding one of the grooves, but the instant disclosure is not limited thereto. In some embodiments, the shapes of the protrusion and the groove may correspond to each other and may be for example rectangular, trapezoidal, triangular, circular, or the like. In some embodiments, the combining portion 215 of the outer member 21 (corresponding to the assembling ring portion 212) and the positioning portion 225 of the insulated member 22 (corresponding to the mating ring portion 211) may be combined with each other through laser welding.

Please refer to FIG. 4 and FIG. 7. In some embodiments, the insulated member 22 has a through hole 222 in communication with a terminal groove 221. The wire connection module 2 further comprises a terminal 23. The terminal groove 221 is at a central axis longitudinally penetrating the insulated member 22, and the through hole 222 is transversally penetrating the insulated member 22. The terminal 23 has a thorn portion 232. After the terminal 23 is inserted into the terminal groove 221, the thorn portion 232 of the terminal 232 is assembled and engaged with the through hole 222, thereby limiting the movement of the terminal 23 with respect to the terminal groove 221. In some embodiments, the thorn portion 232 may be formed by stamping the terminal 23 with a processing tool (such as a needle-shaped tool) to form a reverse hook.

Please refer to FIG. 4 and FIG. 6. In some embodiments, an outer lateral surface 22 of the insulated member 22 has a recessed portion 223 corresponding to an opening of the through hole 222. After the insulated member 22 is formed by injection molding in a mold and after the mold is opened, the processing tool for forming the through hole 222 will be detached from the insulated member 22. The processing tool for forming the through hole is a rectangular stepped structure, and the insulated member 22 is a circular cylindrical structure. during the demolding process, the processing tool is detached from insulated member 22 along a direction perpendicular to the insulated member 22, and a rectangular notch is thus formed on the outer lateral surface of the insulated member 22, so that the recessed portion 223 is formed on the outer lateral surface of the insulated member 22 corresponding to the opening of the through hole 222.

Please refer to FIG. 3 and FIG. 7. In some embodiments, the tail cap 24 has a fitting ring portion 242. A length of the fitting ring portion 242 is less than a length of the assembling ring portion 212, and an inner diameter of the fitting ring portion 242 is greater than or equal to the outer diameter of the assembling ring portion 212. When fitting ring portion 242 is fitted over the assembling ring portion 212, laser welding is applied at an outer peripheral portion of the fitting ring portion 242, so that the fitting ring portion 242 and the assembling ring portion 212 are connected to and combined with each other. In some embodiments, the length of the fitting ring portion 242 is greater than half of the length of the assembling ring portion 212, thereby enhancing the structural stability of the combination of the fitting ring portion 242 and the assembling ring portion 212.

Please refer to FIG. 4 and FIG. 8. In some embodiments, the outer member 21 has a plurality of protruding spots 216. After the outer member 21 is combined with the insulated member 22, the protruding spots 216 abut against the outer portion of the insulated member 22, thereby limiting the movement of the insulated member 22 with respect to the outer member 21 and increasing the positional stability of the insulated member 22 in the outer member 21.

According to some embodiments of the instant disclosure, the tail cap is mated with the outer portion of the outer member, and a large portion of the outer member encloses the outer portion of the insulated member. Therefore, when the wire connection module is impacted or displaced, the insulated member is not displaced or detached from the outer member due to the impact of the wire connection member. Moreover, in some embodiments, through the combination between the combining portions of the outer member and the positioning portions of the insulated member, the degree of freedom of the axial rotation of the outer member with respect to the insulated member can be limited, and a mistake-proofing function can be provided for the combination between the outer member and the insulated member. Therefore, the insulated member can be properly limited in the outer member, and thus the stability of the insulated member can be enhanced and the orientation of the insulated member can be properly configured.

While the instant disclosure has been described by the way of example and in terms of the preferred embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A wire connection module, comprising:
an outer member having a receiving groove, wherein one of two ends of the outer member has a mating side, and the other end of the outer member has an assembling side;
an insulated member in the receiving groove; and
a tail cap mated with the assembling side of the outer member and assembled outside an outer portion of the outer member.

2. The wire connection module according to claim 1, wherein the outer member has a plurality of combining portions, the insulated member has a plurality of positioning portions, and each of the combining portions is engaged with a corresponding one of the positioning portions.

3. The wire connection module according to claim 2, wherein each of the combining portions is a groove, and each of the positioning portions is a protrusion.

4. The wire connection module according to claim 1, further comprising a terminal, wherein the insulated member has a terminal groove for being assembled with the terminal.

5. The wire connection module according to claim 4, wherein the insulated member has a through hole in communication with the terminal groove, and the terminal has a thorn portion engaged with the through hole.

6. The wire connection module according to claim 5, wherein an outer lateral surface of the insulated member has a recessed portion corresponding to an opening of the through hole.

7. The wire connection module according to claim 1, wherein the mating side of the outer member has a mating ring portion, the assembling side of the outer member has an assembling ring portion, and an outer diameter of the mating ring portion is less than an outer diameter of the assembling ring portion.

8. The wire connection module according to claim 7, wherein the tail cap has a fitting ring portion fitted over the assembling ring portion, and a length of the fitting ring portion is less than a length of the assembling ring portion.

9. A plug connector, comprising:
a housing having a plurality of receiving spaces, wherein the housing has a plurality of first mating surfaces respectively at inner sides of the receiving spaces; and
a plurality of wire connection modules respectively in the receiving spaces, wherein each of the wire connection modules comprises an outer member, an insulated member, and a tail cap; for each of the wire connection modules, the outer member has a receiving groove, one of two ends of the outer member has a mating side, the other end of the outer member has an assembling side, the insulated member is in the receiving groove, and the tail cap is mated with the assembling side of the outer member and assembled outside an outer portion of the outer member; an outer portion of each of the tail caps is positioned at a corresponding one of the first mating surfaces.

10. The plug connector according to claim 9, wherein for each of the wire connection modules, the mating side of the outer member has a mating ring portion, the assembling side of the outer member has an assembling ring portion, an outer diameter of the mating ring portion is less than an outer diameter of the assembling ring portion, the outer member has a bent portion between the mating ring portion and the assembling ring portion; the housing comprises a plurality of stopping blocks, and each of the stopping blocks is at the inner side of a corresponding one of the receiving spaces and leans against a corresponding one of the bent portions.

11. The plug connector according to claim 10, wherein the housing has a plurality of second mating surfaces respectively at the inner sides of the receiving spaces, each of the second mating surfaces is between a corresponding one of the first mating surfaces and a corresponding one of the stopping blocks, and the outer portion of each of the outer members is positioned at a corresponding one of the second mating surfaces.
